(19) United States
(12) Patent Application Publication
(10) Pub. No.: US 2009/0135317 A1
(43) Pub. Date: May 28, 2009

(54) ADDRESSABLE BACKLIGHT FOR LCD PANEL

(75) Inventors: JEFF RONALD LYNAM, Roanoke, VA (US); Donald Janeczko, Fincastle, VA (US)

Correspondence Address: RATNERPRESTIA, P.O. BOX 980, VALLEY FORGE, PA, 19482, US

(73) Assignee: ITT MANUFACTURING ENTERPRISES, INC., Wilmington, DE (US)

(21) Appl. No.: 12/324,003

(22) Filed: Nov. 26, 2008

Related U.S. Application Data
(63) Continuation-in-part of application No. 11/644,722, filed on Dec. 22, 2006.

(51) Int. Cl. G02F 1/13

(52) U.S. Cl. 349/5; 445/24

(57) ABSTRACT

A display unit includes an LCD which receives an array of pixel data for displaying an image at a first dynamic range. A projector projects colored light of the image at a second dynamic range. The LCD combines the array of pixel data with the colored light to display the image at a third dynamic range. The third dynamic range is greater than the first or second dynamic range.

This application is a Continuation-in-Part of U.S. application Ser. No. 11/644,722, filed Dec. 22, 2006, the contents of which are incorporated herein by reference.

### TECHNICAL FIELD

The present invention relates, in general, to a display unit and, more specifically, to a display unit including an LCD panel and a projection display which provides an addressable backlight image to the LCD panel.

### BACKGROUND OF THE INVENTION

Liquid crystal materials emit no light of their own. They do, however, reflect and transmit light from external light sources. Accordingly, when using liquid crystal materials in a display, it is necessary to back light the display.

A conventional flat screen liquid crystal display (LCD) includes a matrix of thin film transistors (TFTs) fabricated on a substrate of glass or another transparent material. A liquid crystal film is disposed over the substrate and the TFTs. Addressing of the TFTs by gate lines deposited on the substrate during TFT fabrication causes selected TFTs to conduct electrical current and charges the liquid crystal film in the vicinity of the selected TFTs. Charging of the liquid crystal film alters the opacity of the film, and affects a local change in light transmission of the liquid crystal film. Hence, the TFTs define display cells or pixels in the liquid crystal film. Typically, the opacity of each pixel is charged to one of several discrete opacity levels to implement a luminosity gray scale, and so the pixel is a gray scale pixel.

Because a backlit LCD varies only the luminosity of the light to produce gray scale pixels, an LCD also requires means for coloring the pixels. U.S. Pat. No. 6,975,369 describes a method of coloring LCD pixels, which includes use of a colorizing backlight. As described, an array of backlight elements each includes a first component color light emitting diode (LED), a second component color LED and a third component color LED, such as red, green and blue, respectively. Each of the three LEDs is optically coupled to a corresponding pixel of the LCD. In this arrangement, each component color LED corresponds to a color pixel. In operation, the red, green and blue LEDs emit light toward the LCD. The luminance of each of the pixels is modulated via the LCD pixels using the TFTs to create a transmitted light luminance modulation across the area of the display. In particular, LCD pixels coupled to the red LEDs modulate the red light component, LCD pixels coupled to the green LEDs modulate the green light component, and LCD pixels coupled to the blue LEDs modulate the blue light component. By selective operation of the pixels for each backlight element, a desired color blending is achieved. The combination of gray scale pixels defines a full-color pixel.

Conventional flat screen displays suffer certain disadvantages. First, the colorizing backlight of the conventional flat screen display modulates only chrominance of the backlight. As a result, luminance range of the flat screen display is limited. Second, conventional flat screen displays require complex controls for turning on the LEDs at certain levels to produce blended colors, making manufacture of conventional flat screen displays difficult and expensive.

### SUMMARY OF THE INVENTION

To meet this and other needs, and in view of its purposes, the present invention provides a display unit and method of manufacturing a display unit. In one embodiment of the invention, the display unit includes an LCD which receives an array of pixel data for displaying an image at a first dynamic range. A projector projects colored light of the image at a second dynamic range. The LCD combines the array of pixel data with the colored light to display the image at a third dynamic range. The third dynamic range is greater than the first or second dynamic range.

The present invention also includes a method of manufacturing a display unit. The method includes the following steps:
(a) manufacturing a projection display and an LCD panel, wherein the LCD panel is configured to receive an image having a first dynamic range, and the projection display is configured to project an image having a second dynamic range;
(b) arranging the projection display within a range of the LCD panel for the projection display to backlight the LCD panel, and
(c) displaying on the LCD panel the image having a third dynamic range, wherein the third dynamic range is greater than the first or second dynamic range.

### BRIEF DESCRIPTION OF THE DRAWINGS

The invention is best understood from the following detailed description when read in connection with the accompanying drawing. Included in the drawing are the following figures:

FIG. 1 is a side view of a liquid crystal display (LCD), according to an exemplary embodiment of the present invention;

FIG. 2 is an exploded view of a liquid crystal display, according to an exemplary embodiment of the present invention;

FIG. 3 is a side view of an exemplary relationship between an active pixel display (APD) and a liquid crystal display, according to an embodiment of the present invention;

FIG. 4 is a front view of the top left corner of a combined display format illustrating a 4:1 relationship of background active color pixels to foreground LCD pixels, according to an exemplary embodiment of the present invention;

FIG. 5 is a front view of the top left corner of a combined display format illustrating a 1:1 relationship of background active color pixels to foreground LCD pixels, according to an exemplary embodiment of the present invention;

FIG. 6 is a front view of the top left corner of a combined display format illustrating a 1:1.6 relationship of background active color pixels to foreground LCD pixels, according to an exemplary embodiment of the present invention;

FIG. 7 is a block diagram showing synchronization between an LCD and an APD, according to an exemplary embodiment of the present invention;

FIG. 8 is a side view of an optional field format magnifier sandwiched between an LCD and an APD, according to an exemplary embodiment of the present invention;

FIG. 9 is a side view of an optional field format minifier sandwiched between an LCD and an APD, according to an exemplary embodiment of the present invention;

FIG. 10A is a side view of a relay lens for frame field matching between an LCD and an APD, according to an exemplary embodiment of the present invention;

FIG. 10B is a side view of a 1:1 fiber optic for frame field matching between an LCD and an APD, according to an exemplary embodiment of the present invention;

FIG. 10C is a side view of a minifying fiber optic taper for frame field matching between an LCD and an APD, according to an exemplary embodiment of the present invention;

FIG. 11 is a side view of a projection display backlight unit for an LCD, according to an exemplary embodiment of the present invention;

FIG. 12 is an exploded view of a projection display backlight unit for an LCD, according to an exemplary embodiment of the present invention;

FIG. 13 is a side view of a projection display backlight unit that is located to a side of an LCD, according to an exemplary embodiment of the present invention; and

FIG. 14 is a block diagram of a system used to synchronize a projection display backlight unit and an LCD, according to an exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

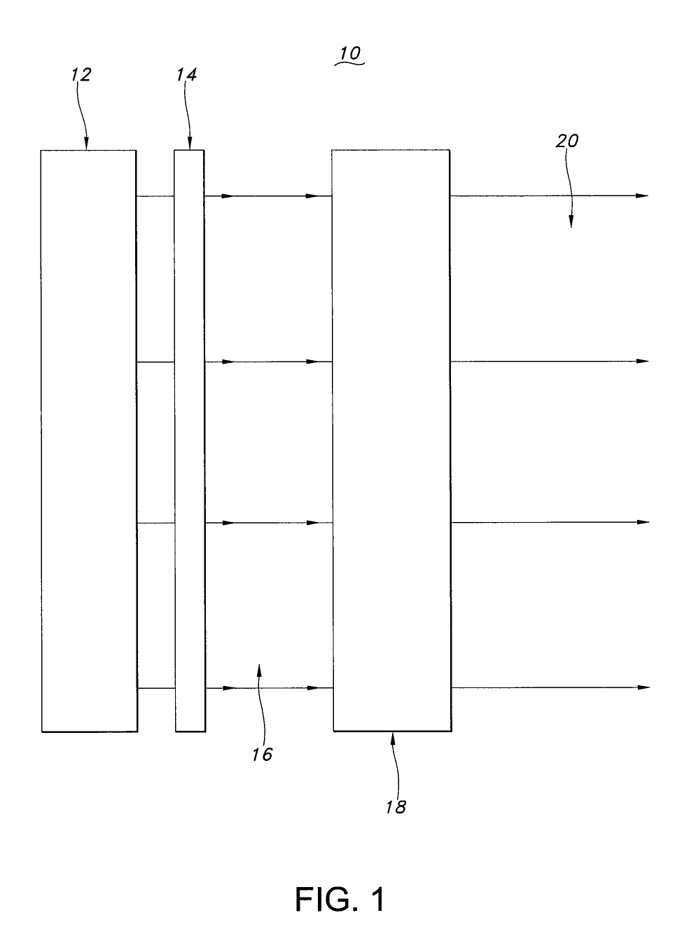

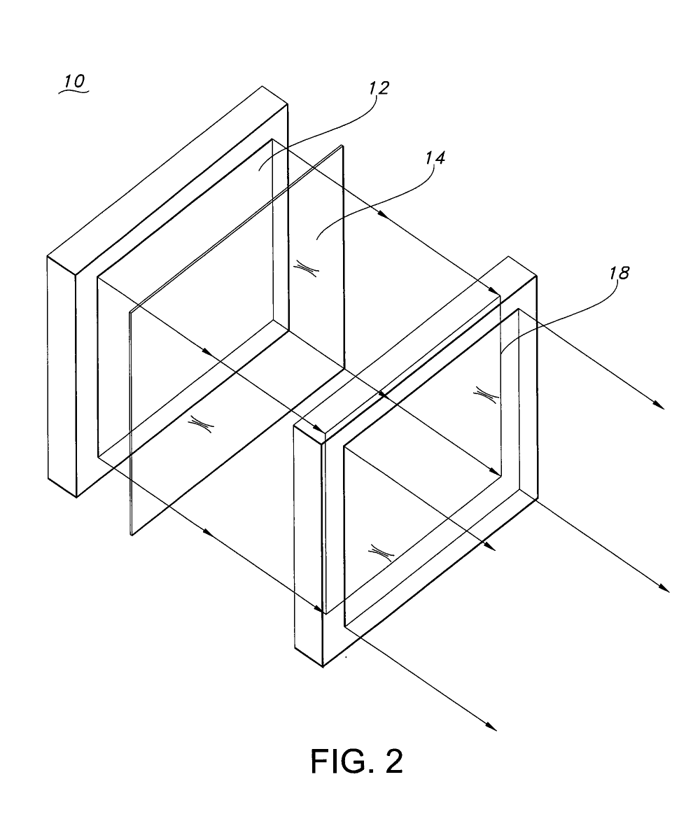

With reference to FIGS. 1 and 2, a display unit 10 according to an exemplary embodiment of the present invention includes an active pixel display (APD) 12 disposed behind a liquid crystal display (LCD) 18. The LCD 18 may be, for example, a transmissive or transflexive LCD. The APD 12 provides a backlight source for LCD 18. FIGS. 1 and 2 also show an optional field format modifier 14 that may be used to modify the relationship between the active display area of APD 12 and the active display area of LCD 18. Optional field format modifier 14 is described in more detail later.

As shown in FIG. 1, APD 12 emits chrominance and luminance modulated light into illumination output region 16. The LCD 18 further modulates the luminosity of the light to form a final image in display output region 20.

The APD 12 may be any active pixel display of any light emitting technology. For example, APD 12 may be an active matrix organic light emitting diode (AMOLED).

An AMOLED is made up of an array of organic light emitting diodes (OLEDs). Each OLED includes an anode layer and a cathode layer, with at least two organic semiconductor layers sandwiched between them. One of the organic semiconductor layers is a conductor of positively charged holes and the other is a conductor of electrons. When a voltage is applied to the device, the excess electrons jump the gap towards the holes and emit light. The OLED may be made to emit colored light, for example, by placing a color filter over a white-light-emitting OLED.

The anode layer of each OLED is disposed on top of a thin film transistor (TFT) array that forms a matrix. The TFT matrix controls both the chrominance and luminance of the OLEDs. Addressing of the TFTs by gate lines deposited on the substrate during TFT fabrication causes selected TFTs to conduct electrical current. Those selected TFTs turn on selected OLEDs to produce blended colors as well as different luminance values, thus forming an image.

Thus, active pixel display 12 modulates both luminance and chrominance. When used as a backlight for LCD 18, active pixel display 12 acts as a primary light source and a light modulator and LCD 18 acts as a secondary light modulator. In this way, LCD 18 provides an additional level of luminance control. For example, if each APD pixel provides 256 individual luminance levels, and each LCD pixel provides 16 additional luminance levels, then system 10 has a dynamic range of 4096 luminance levels per pixel.

Further, using APD 12 as a backlight for LCD 18 provides for easy assembly. The present invention advantageously assembles two separate and independently manufactured units. Both units, namely the APD panel and the LCD panel, may be separately manufactured in any conventional manner. After manufacture, both units may be integrated to form display unit 10, where APD panel 12 is disposed behind LCD panel 18. The resulting dynamic range of display unit 10 is the product of the individual dynamic range of the APD panel and the individual dynamic range of the LCD panel.

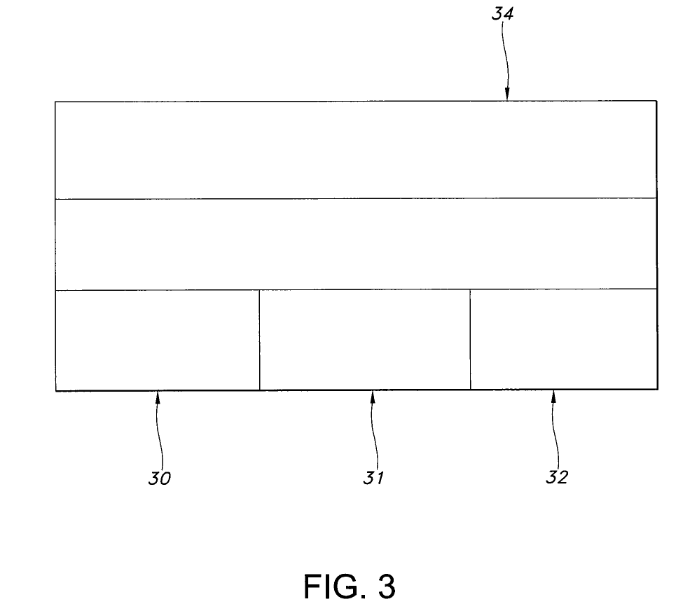

FIG. 3 shows a general arrangement of APD pixels 30, 31 and 32 disposed behind LCD pixel 34. For example, pixel 30 emits red light, pixel 31 emits green light, and pixel 32 emits blue light. In this manner, each LCD pixel 34 emits green light, blue light, red light or any blended color produced by combining the three colors. As is known in the art, selective blending of three primary colors such as red, green and blue generally produces a full range of colors suitable for color display purposes. As previously described, each APD pixel 30, 31 and 32 emits light that is both luminance modulated and chrominance modulated in the direction of LCD pixel 34. The LCD pixel 34 then provides additional luminance modulation.

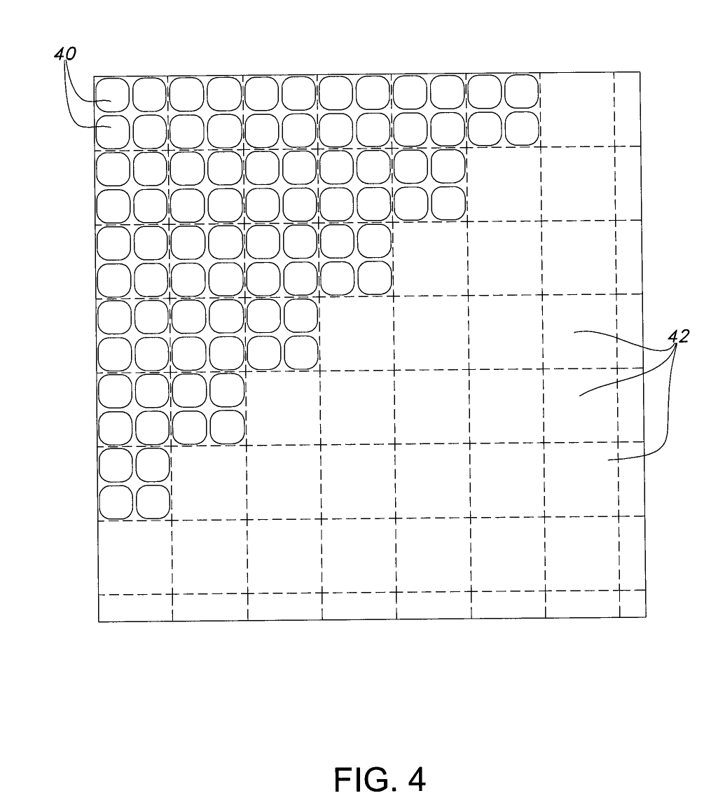

FIGS. 4-6 show a top corner portion of various combined display formats and illustrate the relationship of background active color pixels to respective foreground LCD pixels. Pixel overlay relationship is a direct factor of the size spacing and fill factor of each individual pixel (in the APD) with respect to pixel or pixels of a corresponding secondary display (e.g. the LCD).

Referring first to FIG. 4, there is shown a 4:1 pixel overlay relationship. As shown, active color pixels 40 are smaller than LCD pixel 42. More specifically, four active color pixels 40 are disposed behind one LCD pixel 42.

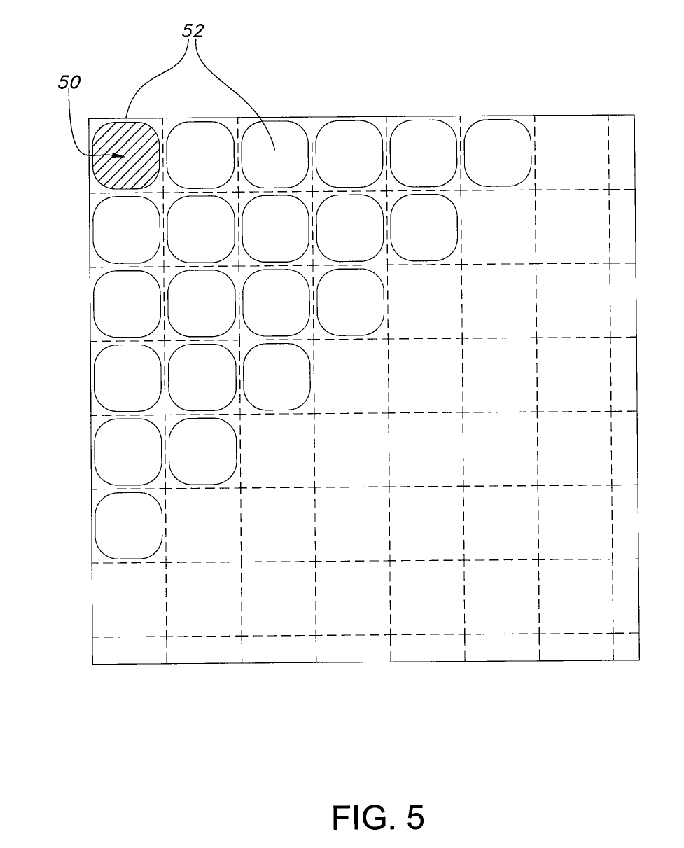

As another example, FIG. 5 shows a 1:1 pixel overlay relationship. As shown, each active color pixel 50 is the same size as each LCD pixel 52. Thus, each active color pixel 50 is disposed behind one LCD pixel 52.

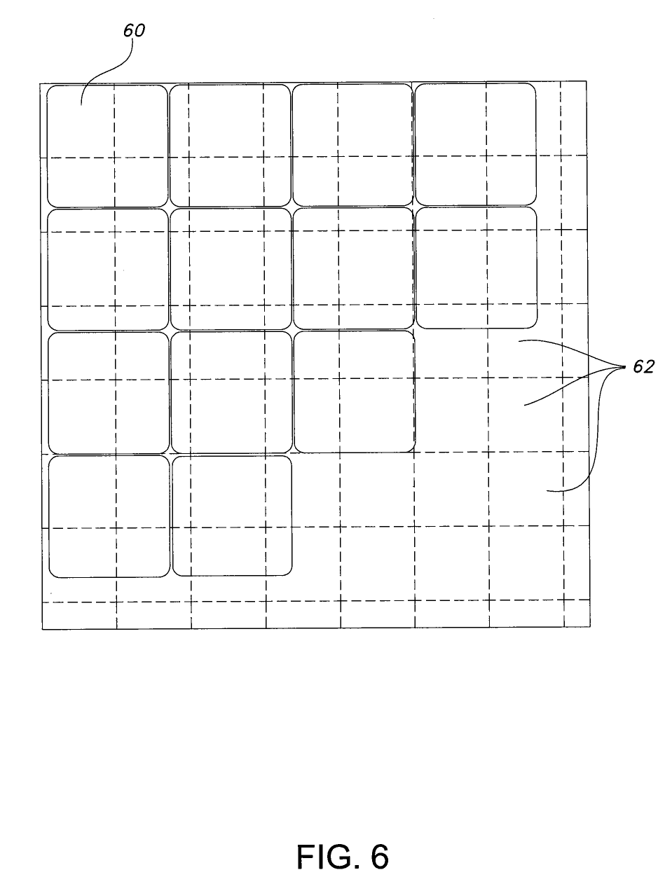

Still another example, FIG. 6 shows a 1:1.6 pixel overlay relationship. As shown, each active color pixel 60 is larger than each LCD pixel 62, by as much as 60%.

It will be appreciated that one skilled in the art may arrange the background active color pixels and the foreground LCD pixels to form any other pixel overlay relationship.

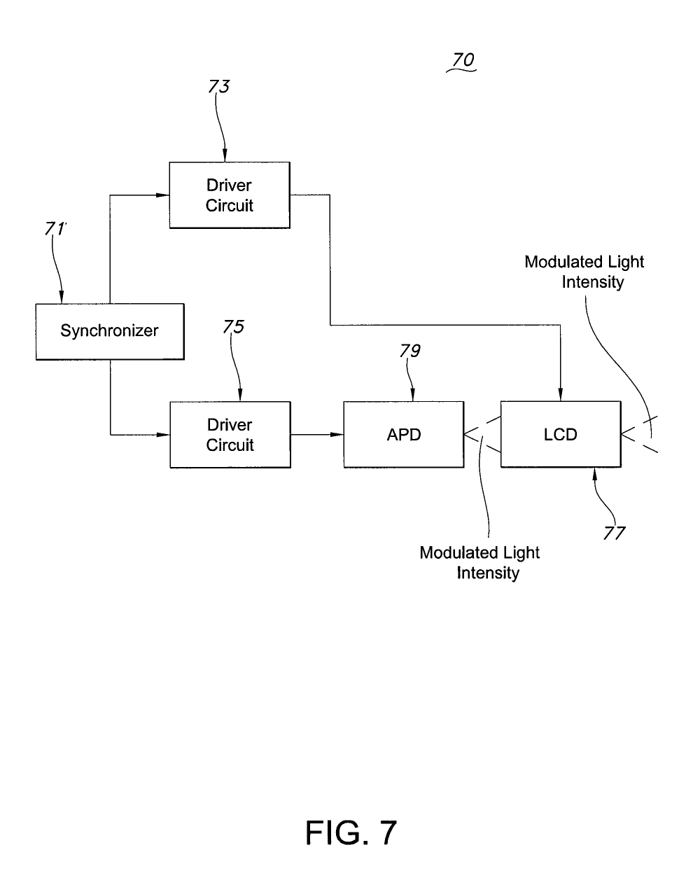

FIG. 7 illustrates an example of synchronization of the APD pixels with the LCD pixels. As shown, display unit 70 includes synchronizer 71, driver circuits 73 and 75, LCD 77 and APD 79. Synchronizer 71 generates a clock signal having a predetermined frequency. The clock signal is provided to both driver circuit 73 and driver circuit 75. Driver circuit 73 controls LCD 77 and driver circuit 75 controls APD 79. In this manner, display unit 70 synchronizes the pixels of LCD 77 with the pixels of APD 79 to the same clock signal. A synchronized image of luminance values from both LCD 77 and APD 79 and chrominance values from APD 79 are displayed by the output of the front panel of LCD 77, as best shown in FIGS. 1-3.

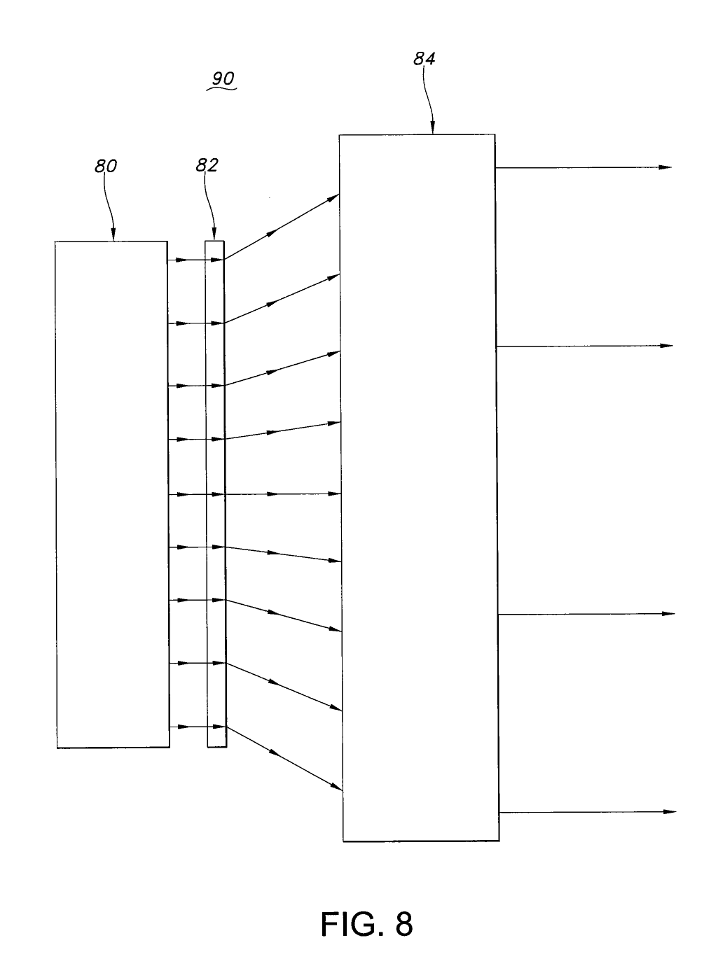

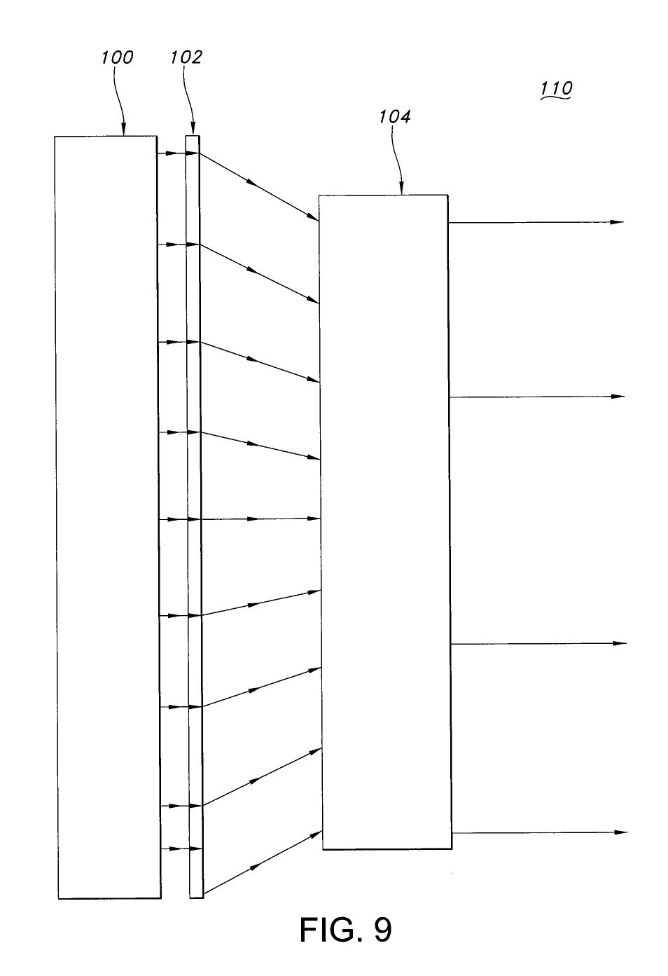

FIGS. 8 and 9 illustrate an optional field format modifier inserted between an LCD panel and an APD panel. Optional field format modifier 82 or 102 may be used to optimize the active pixel-to-LCD display format overlay relationship and/or the individual pixel-to-pixel overlay dimensional relationship. Field format modifiers 82 or 102 may be placed between the APD panel and the LCD panel. The field format modifier may be, for example, a relay lens, a micro-fresnel lens, and/or a fiber optic taper.

Referring to FIG. 8, display unit 90 includes APD 80, field format magnifier 82 and LCD 84. In the exemplary embodiment, LCD 84 has a larger display area than APD 80. Field format magnifier 82 directs the light emitted from APD 80 toward a larger area of LCD 84. In this manner, an APD may be used to backlight an LCD that has a larger display area than the APD.

Referring to FIG. 9, display unit 110 includes APD 100, field format minifier 102 and LCD 104. In the exemplary embodiment, LCD 104 has a smaller display area than APD 100. Field format minifier 102 directs the light emitted from APD 100 toward a smaller area of LCD 104. In this manner, an APD may be used to backlight an LCD that has a smaller display area than the APD.

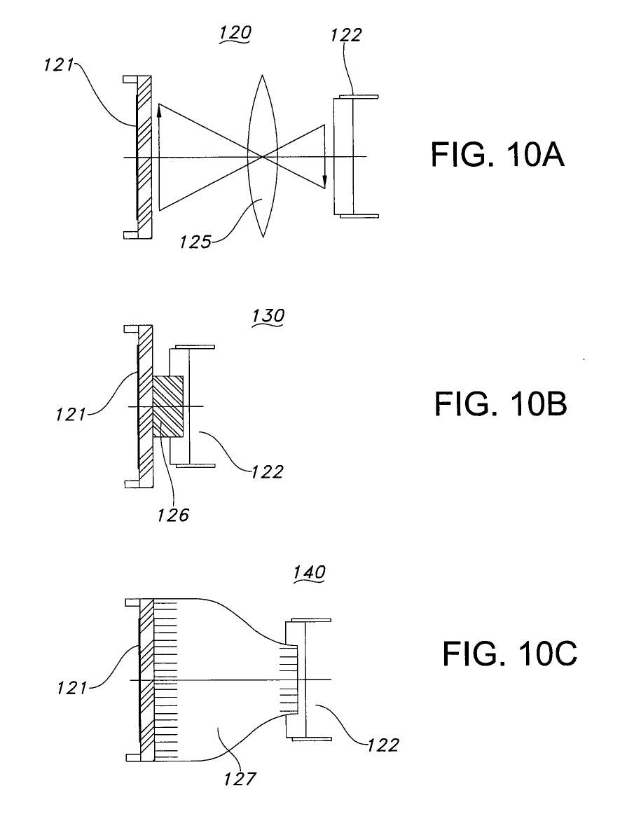

Referring to FIGS. 10A, 10B and 10C, there are shown exemplary field format modifiers. Display unit 120 includes relay optic (lens) 125 disposed between APD 121 and LCD 122 (only portions of an APD and an LCD are shown). Relay optic 125 is separated completely from the APD and the LCD by way of an air gap on both sides of the relay optic. As another example, display unit 130 includes a 1:1 fiber optic disposed between APD 121 and LCD 122. Still another example, display unit 140 includes a minifying fiber optic taper disposed between APD 121 and LCD 122 for reducing the size of the image between the APD and the LCD. Although not shown, a magnifying fiber optic taper (the taper is an inverse of the taper shown in FIG. 10C) may also be used for enlarging the image between the APD and the LCD.

Actual design intent affects how and when magnification or minification is applied. In cases where the design intent is to maximize or more equally match the overall format areas of each display, less consideration may be given to a 1-to-1 pixel overlay match and some fractional overlay may result. In cases where pixel-to-pixel matching is more important, less concern may be given to an under-filled or over-filled field display.

According to yet another exemplary embodiment, the APD may be a projection display unit (e.g., a scanning micro-projector). The projection display unit may be configured to provide one or more outwardly steered (projected) light beams onto the pixel array of the LCD. The projected beams may be arranged so as to impinge upon different portions of the pixel array and together may cover the entire pixel array. If the scanning micro-projector is a color projector, the LCD may display an image to a viewer based upon the pixel locations impinged upon by the projector.

Furthermore, the LCD panel may receive image data from an image processor and display a corresponding image on the LCD panel. The image data may include only luminance data for displaying a black and white image on the LCD panel. When the micro-projector is added to the system, however, in order to project a color image (for example) onto the LCD panel, the LCD panel may display the combination of the luminance data and the color (chrominance) data. In this manner, the system may be arranged to provide a dynamic range of an image that is greater than the individual dynamic range of the image data processed for the LCD panel or the image data projected onto the LCD panel by the micro-projector.

In another embodiment, the LCD panel may receive image data from an image processor that includes both luminance data and chrominance data for display to a viewer. The image data presented to the viewer may thus include a certain dynamic range (referred to herein as a first dynamic range) based on the data provided by the image processor. In addition, the LCD panel may receive a projected color image from the micro-projector. The projected color image may be based on another dynamic range (referred to herein as a second dynamic range). Having the benefit of two sets of image data, one coming from the image processor and the other coming from the micro-projector, the viewer may view an improved image that has a third dynamic range. The third dynamic range is typically the first dynamic range multiplied by the second dynamic range, thereby providing a much improved dynamic range to the viewer.

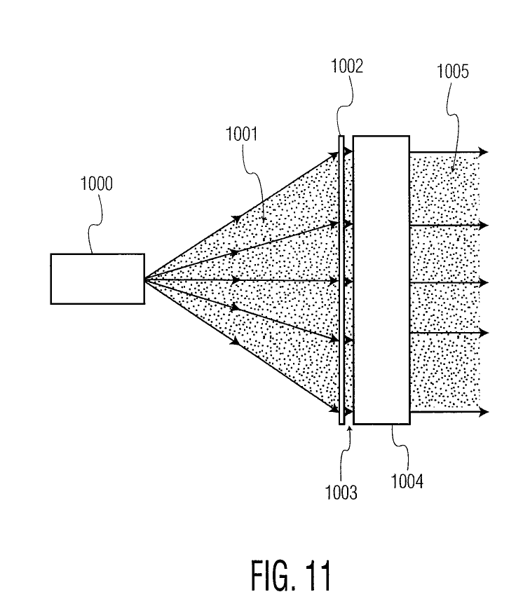

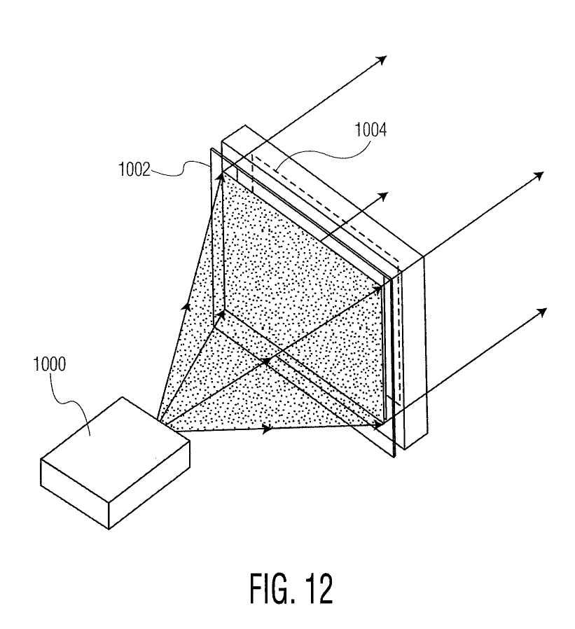

An exemplary projection display backlight 1000 is illustrated in FIGS. 11 and 12. The illustrated projection display backlight 1000 projects one or more light beams from each pixel through illumination output region 1001. The projected light beams are arranged to form colored light of an image at a predetermined dynamic range. The colored light of the image projected through illumination output region 1001 may be re-directed by an optional field format modifier 1002 into modified illumination output region 1003. The colored light of the image then passes through LCD 1004, where the dynamic range may further be enhanced. The image may be viewed on display output region 1005.

The arrows shown in illumination output region 1001, modified illumination output region 1003 and display output region 1005 represent the direction in which the light beams are directed. As shown, the projection display backlight 1000 is much smaller than the panel of LCD 1004. However, the projection display backlight 1000 projects the light beams outwardly from a distance that is configured to allow the projecting light beams to sweep the entire panel of the LCD. Thus, in the embodiment shown in FIGS. 11 and 12, the projected image is sized to fit the panel of LCD 1004.

In the embodiment of FIGS. 11 and 12, the optional field format modifier 1002 is a field flattener (e.g., a collimator). As shown, the field flattener re-directs the outwardly projected light beams so that they strike LCD 1004 from a direction perpendicular to LCD 1004. Thus, the image may be viewed directly without distortion. In other embodiments, optional field format modifier 1002 may be a field format minifier or magnifier, if the projected image from the micro-projector is larger or smaller than LCD 1004, respectively. Alternatively, the field format modifier 1002 may include a field format minifier/magnifier and a field flattener.

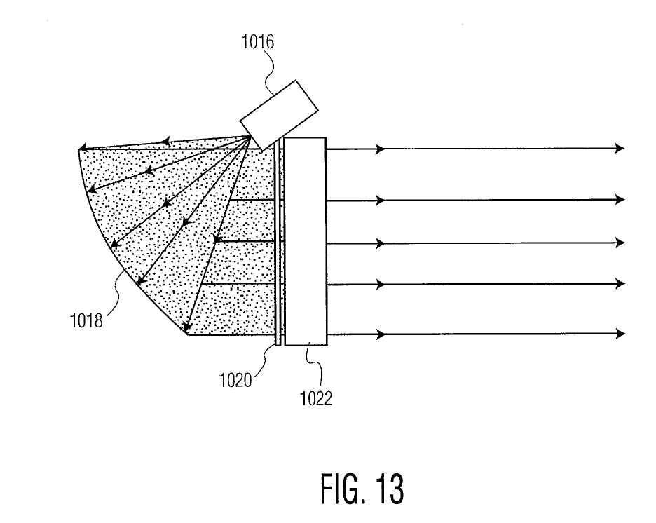

Because projection display backlights are relatively small, they are suited for night vision goggles. For example, they may be smaller and lighter than the APDs of the embodiments shown in FIGS. 1 and 2. Projection display backlights may also be advantageous in tightly-spaced applications, because they do not need to be placed directly behind the LCD, as in the example shown in FIG. 13.

FIG. 13 shows an embodiment of a projection display backlight 1016 that is located above LCD 1022. As illustrated, projection display backlight 1016 projects light beams in one direction toward parabolic mirror 1018. The parabolic mirror then reflects the light beams in another direction toward LCD 1022, this other direction being perpendicular to LCD 1022. As with the embodiment shown in FIGS. 11 and 12, an optional field format modifier 1020 may be included if necessary. While FIG. 13 illustrates an embodiment wherein the projection display backlight 1016 is located above the LCD, one of ordinary skill in the art will recognize that the projection display backlight 1016 may be located in other positions with the light beams re-directed toward the LCD using reflecting mirrors.

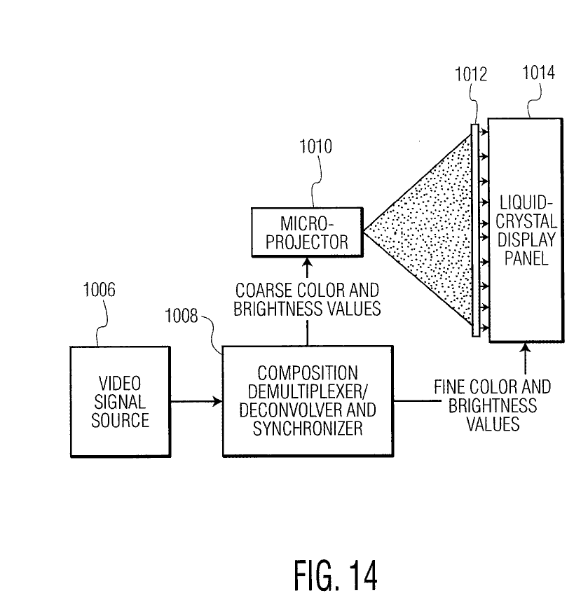

FIG. 14 is a block diagram illustrating the electronics used to drive and synchronize a projection display backlight and an LCD according to any of the embodiments shown in FIGS. 11-13. The illustrated electronics include a video signal source 1006, a demultiplexer/deconvolver and synchronizer (CDDS) 1008, a micro-projector 1010, an LCD panel 1014 and an optional field format modifier 1012.

The video source 1006 provides video/image signals to CDDS 1008. The video source may be, for example, a camera, a computer, a game console, a DVD player, or a television receiver. The CDDS 1008 processes the received video/image signals. By way of example, the CDDS 1008 extracts coarse color and brightness values (a first dynamic range) from the received video/image signals and provides them to micro-projector 1010. Similarly, CDDS 1008 extracts fine color and brightness signals (a second dynamic range) and provides them to LCD panel 1014. In this manner, the LCD receives an array of pixel data for displaying the image at a predetermined third dynamic range. Typically, the third dynamic range is equal to the first dynamic range multiplied by the second dynamic range.

The video signals sent to micro-projector 1010 and LCD panel 1014 are synchronized to each other by the same clock signal, which may reside in CDDS 1008. Driver circuits in micro-projector 1010 and LCD 1014 are synchronized to each other, thereby providing a combined video on LCD 1014.

What is claimed:

1. A display unit comprising:
an LCD configured to receive an array of pixel data for displaying an image at a first dynamic range;
a projector configured to project colored light of the image at a second dynamic range; and
the LCD configured to combine the array of pixel data with the colored light to display the image at a third dynamic range,
wherein the third dynamic range is greater than the first or second dynamic range.

2. The display unit of claim 1, further comprising a collimator disposed between the LCD and the projector.

3. The display unit of claim 1, further comprising a field format magnifier disposed between the projector and the LCD panel for enlarging the colored light of the image provided to the LCD.

4. The display unit of claim 1, further comprising a field format minifier disposed between the projector and the LCD for reducing the colored light of the image provided to the LCD.

5. The display unit of claim 1, wherein the projector is a scanning micro-projector.

6. The display unit of claim 1, further comprising a synchronizer module for synchronizing the image transmitted from a video signal source to the LCD with the colored light of the image projected by the projector.

7. The display unit of claim 1, wherein the projector is disposed behind the LCD and configured to directly illuminate the LCD.

8. The display unit of claim 1, wherein the projector is disposed above the LCD.

9. The display unit of claim 8, wherein:
the projector is configured to project the colored light of the image away from the LCD toward a mirror, and
the mirror is configured to re-direct the colored light of the image toward the LCD.

10. A method of manufacturing a display unit comprising the steps of:
(a) manufacturing a projection display and an LCD panel; and
(b) arranging the projection display within a range of the LCD panel for backlighting the LCD panel.

11. The method of claim 10, wherein step (b) further comprises vertically stacking the LCD panel and the projection display one behind the other.

12. The method of claim 10, further comprising the step of:
(c) vertically stacking a collimator between the LCD panel and the projection display.

13. The method of claim 10, wherein step (b) further comprises arranging the projection display above the LCD panel.

14. The method of claim 13, further comprising the step of:
(c) arranging a mirror within a range of the projection display for re-directing light projected from the projection display towards the LCD panel.

15. The method of claim 10, further including the steps of:
(c) configuring the LCD panel to receive an array of pixel data for displaying an image at a first dynamic range;
(d) configuring the projection display to project colored light of the image at a second dynamic range; and
(e) configuring the LCD panel to combine the array of pixel data with the projected colored light and display the image at a third dynamic range.
